(19) United States
(12) Patent Application Publication
(10) Pub. No.: US 2012/0293826 A1
(43) Pub. Date: Nov. 22, 2012

(54) SYSTEMS AND METHODS FOR PROVIDING MULTIPLE IMAGES

(76) Inventor: SRIVASTAVA SAURABH, Bangalore (IN)

(21) Appl. No.: 13/111,439

(22) Filed: May 19, 2011

(51) Int. Cl. G06F 15/00

(52) U.S. Cl. 358/1.15

(57) ABSTRACT

One example provides a network system for providing multiple images. The network system comprises a system comprising a memory for storing computer executable instructions and a processing unit for accessing the memory and executing the computer executable instructions. The computer executable instructions can comprise a server. The server can receive a print message from an origin printer that includes a multi-image file that stores a plurality of images. The server can generate a set of commands for printing the plurality of images in a protocol associated with a destination printer identified in the print message.

### BACKGROUND

Cloud computing is location-independent computing, whereby shared servers provide resources, software, and data to computers and other devices on demand. The term “cloud” is used as a metaphor for the Internet, based on the cloud drawing often used to represent computer networks. Cloud computing describes a supplement, consumption, and delivery model for information technologies services based on the Internet, and can involves over-the-Internet provision of dynamically scalable and often virtualized resources. One key characteristic of cloud computing is that the computing is “in the cloud” e.g. the processing (and the related data) is not in a specified, known or static place(s). Details are abstracted from consumers, who no longer have need for expertise in, or control over, the technology infrastructure “in the cloud” that supports them. This is in contrast to a model in which the processing takes place in one or more specific servers that are known.

In some examples of cloud computing, one or more of the aforementioned resources can include a printer, which can be referred to as a cloud printer. In such a situation, nearly any computing device connected to the computing cloud can print to the cloud printer.

### BRIEF DESCRIPTION OF THE DRAWINGS

FIG. 1 illustrates an example of a network system for providing multiple images in a single message.

FIG. 2 illustrates an example of a print message.

FIG. 3 illustrates an example of an album message.

FIG. 4 illustrates an example of a cloud server system that receives multiple images in a single message.

FIG. 5 illustrates an example flowchart of an example method for processing multiple images provided in a single message.

FIG. 6 illustrates an example flowchart of an example method for processing a print message.

FIG. 7 illustrates an example flowchart of an example method for processing an album message.

FIG. 8 illustrates another example of a flowchart of an example method for processing multiple images provided in a single message.

FIG. 9 illustrates an example of a computer system that can be employed to implement the systems and methods illustrated in FIGS. 1-8.

### DETAILED DESCRIPTION

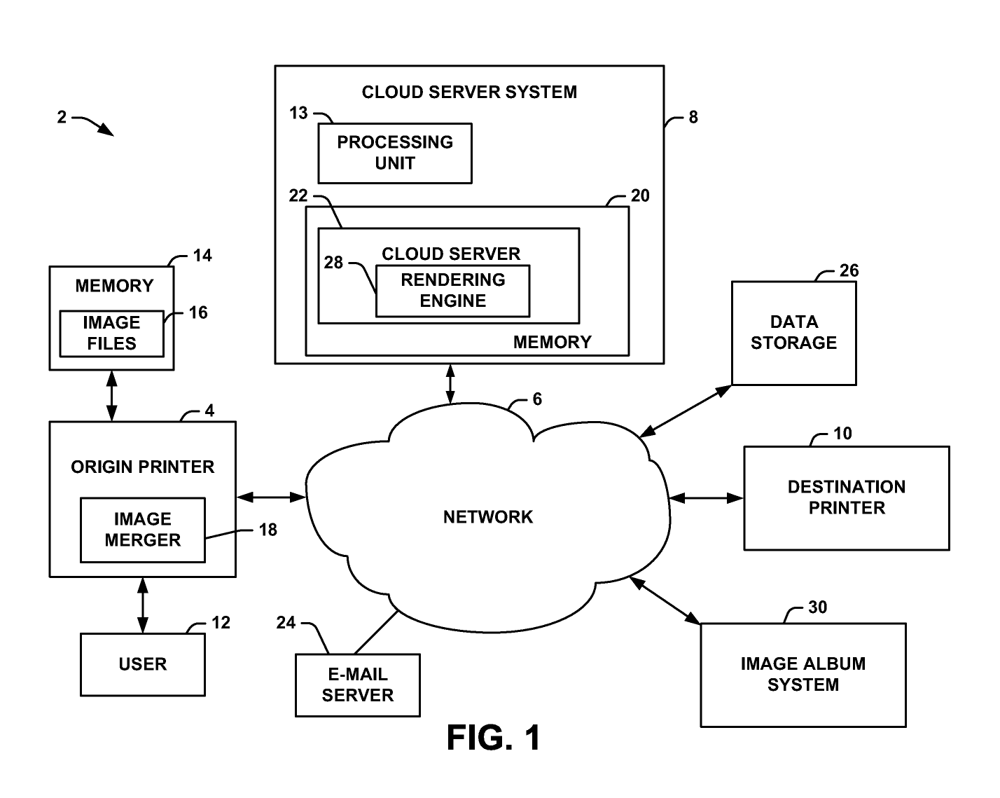

FIG. 1 illustrates an example of a network system 2 for providing multiple images in a single message. The network system 2 can include an origin printer 4. The origin printer 4 can be implemented, for example, as a cloud printer. The origin printer 4 can be implemented, for example, as a printer that can communicate on a network 6. The origin printer 4 can include components (e.g., hardware and/or software) for performing particular functions. The network 6 can be implemented, for example, as the Internet. Nodes on the network 6 can communicate via a communications protocol, such as Transmission Control Protocol/Internet Protocol (TCP/IP), Internet Protocol version 6 (IPv6), etc. The origin printer 4 can be assigned a node address (e.g., an IP address) on the network 6. The origin printer 4 can upload and/or download data to a cloud server system 8 via the network 6. The cloud server system 8 could be implemented, for example, as a printer registration portal. The origin printer 4 can also print data on paper. The network system 2 can also include a destination printer 10 that can be implemented in a manner similar to the origin printer 4. In some examples, both the origin printer 4 and the destination printer 10 can be registered with the cloud server system 8.

For purposes of simplification of explanation, in the present example, different components of the network system 2 are illustrated and described as performing different functions. However, one of ordinary skill in the art will understand and appreciate that the functions of the described components can be performed by different components, and the functionality of several components can be combined and executed on a single component. The components can be implemented, for example, as software (e.g., computer executable instructions), hardware (e.g., an application specific integrated circuit), or as a combination of both (e.g., firmware). In other examples, the components could be distributed among remote devices across the network 6 (e.g., external web services).

In one example, a user 12 of the origin printer 4 can print multiple images on the destination printer 10 with a single upload to the cloud server system 8. For instance, the user 12 can employ the origin printer 4 to upload a file with multiple images stored therein to the cloud server system 8, which file can be referred to as a multi-image file. In one example, multiple images can be provided to the origin printer 4 from a memory 14. Each of the multiple images could be implemented, for example, as an image file 16, such as a JPEG file, a raw image format file, a portable network graphics (PNG) file, etc. In one example, the memory 14 could be implemented as flash memory (e.g., a secure digital (SD) card) physically coupled to the origin printer 4. In other examples, the memory 14 could be implemented on an external system, such that the multiple images can be provided to the origin printer 4 via the network 6. In still other examples, printed images can be scanned into the memory 14. The user 12 can employ a graphical user interface (GUI) of the origin printer 4 and/or an external system to select the multiple image files 16 to be printed at the destination printer 10. Additionally, the user 12 can select the destination printer 10. In some examples, the destination printer 10 can be selected by the user 12 providing an identification of the destination printer 10 (e.g., an e-mail address, a node address, an alias of the destination printer 10, etc.). In other examples, the GUI could provide the user 12 with a list of possible destination printers.

Upon receipt of the multiple image files 16, the origin printer 4 can employ an image merger 18 to merge the multiple image files 16 (selected by the user 12) into a single file to generate the multi-image file. In one example, the multi-image file could be implemented as a portable document format (PDF) file. In such a situation, the image merger 18 could be implemented, for example, as a PDF file generator. The origin printer 4 can generate a print message that includes the multi-image file.

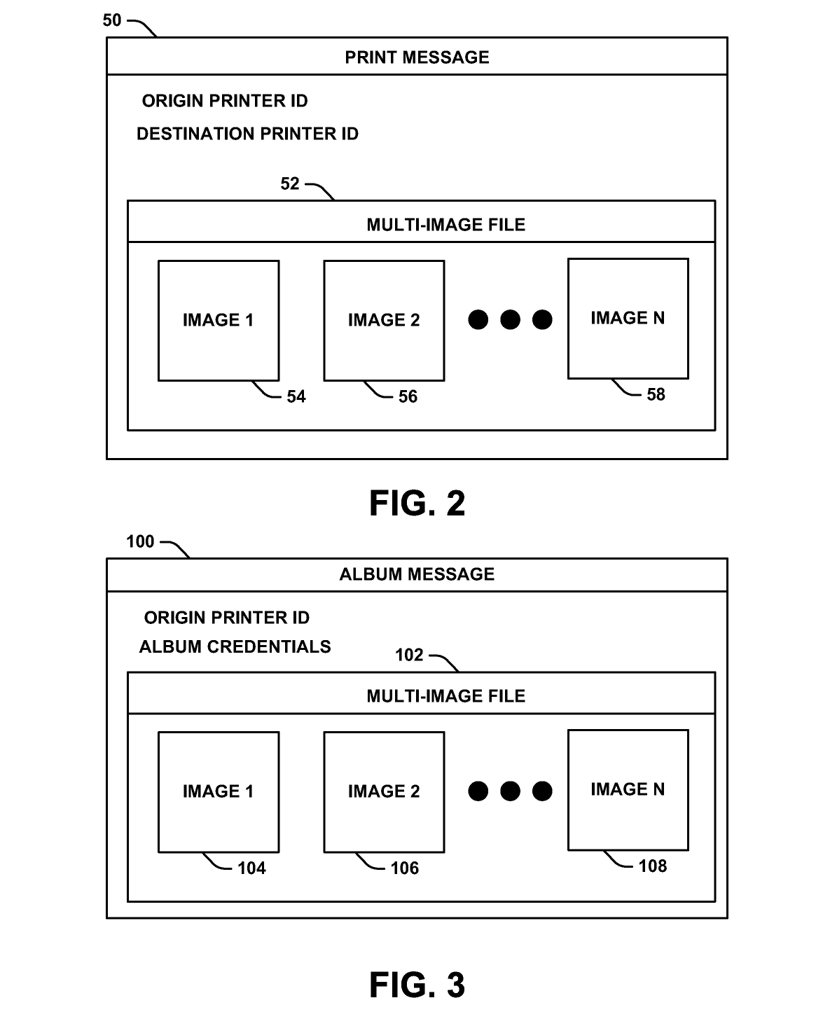

FIG. 2 illustrates an example of a print message 50 generated by the origin printer 4. The print message 50 can include an origin printer ID, labeled in FIG. 2 as “ORIGIN PRINTER ID,” and a destination printer ID, labeled in FIG. 2 as “DESTINATION PRINTER ID.” The print message can include a multi-image file 52, such as the multi-image file generated by the image merger of FIG. 1. The multi-image file can include N number of images 54, 56 and 58 stored therein, where N is an integer greater than or equal to two. Referring back to FIG. 1, upon generation of the multi-image file, the origin printer 4 can upload the print message to the cloud server system 8. The cloud server system 8 can include, for example, a memory 20 for storing computer executable instructions, and a processing unit 13 for accessing the memory 20 and executing the computer executable instructions. The memory 20 can include a cloud server 22. The cloud server 22 could be implemented, for example, as a printer server. The cloud server 22 can receive the print message from the origin printer 4.

In one example, the print message can be implemented as an e-mail message. Moreover, in a situation where the print message is implemented as an e-mail message, the cloud server 22 can receive the print message requesting that images in the multi-image attached to the print message be printed. In such a situation, the origin printer ID can be implemented as a sender e-mail address for the e-mail message, and the destination printer ID could be implemented as a recipient e-mail address for the e-mail message, as explained herein.

As one example, to send an e-mail message (e.g., the print message implemented as an e-mail message) across the network 6 from an origin printer 4 to the cloud server 22 (which e-mail message designates the destination printer 10 as a destination of the print message), the origin printer 4 can connect to an e-mail server 24. In some examples, the e-mail server 24 could be implemented as a Simple Mail Transfer Protocol (SMTP) server. In other examples, the e-mail server 24 could be a proprietary e-mail server 24. The e-mail server 24 can respond to the origin printer 4 with an acknowledgment message. Upon receiving the acknowledgment message, the origin printer 4 can provide an identity message that identifies the origin printer 4. The identity message can include, for example, a client-hostname for the origin printer 4. The e-mail server 24 can respond to the identity message with another acknowledgment message. In response, the origin printer 4 can identify an e-mail address of the origin printer 4 (e.g., MAIL FROM:<sender address>). The e-mail server 24 can respond with another acknowledgment message. In response, the origin printer 4 can identify an address of the destination printer 10 (e.g., “RCPT TO:<recipient address>”), and the e-mail server 24 can respond with another acknowledgment message. In response, the origin printer 4 can provide a request to start transmitting the e-mail message (e.g., the print message), and the e-mail server 24 can respond with a message that requests that the origin printer 4 start the input for the e-mail message, and to end the input with a specific ending identifier (e.g., a carriage return, line feed, a period and another carriage return, line feed“<CRLF>.<CRLF>”). In response, the origin printer 4 can provide the print message (as an e-mail message) to the e-mail server 24 including the specific ending identifier. In response, the e-mail server 24 can provide an acknowledgment of reception the e-mail message, and the origin printer 4 can disconnect from the e-mail server 24.

Upon receipt of the e-mail message, the e-mail server 24 can create an envelope for the e-mail message by employing information provided in the address of the sender and the address of the recipient (the destination printer 10) provided from the origin printer 4. The envelope can have the same or different sender and recipient e-mail addresses as the print message. For purposes of simplification of explanation, it is to be understood that the term “address field” can refer to either a field in a header of the print message, and/or as an address included in the envelope. The e-mail server 24 can provide the envelope and the e-mail message to a delivery agent that can examine the envelope, and provide the print message in an appropriate mailbox, such as a mailbox of the cloud server 22. The cloud server 22 can detect the presence of the print message in the mailbox of the cloud server 22, and retrieve the print message. In this manner, the origin printer 4 can provide a print message (implemented as an e-mail message) that includes the destination printer 10 as a recipient of the e-mail message and the cloud server 22 can receive and process such a print message. In FIG. 1, only one e-mail server 24 is illustrated for purposes of simplification of explanation. However, it is to be understood that the e-mail server 24 could be representative of a plurality of e-mail servers to facilitate the delivery of an e-mail message.

Upon receipt of the print message, the cloud server 22 can access a file in data storage 26 that includes a printer record for the destination printer 10. The data storage 26 could be implemented, for example, as memory (volatile or non-volatile) for storing data, such as a database and/or a table. The data storage 26 could be implemented, for example, as a part of a node the network 6 (e.g., a storage server), and/or a system internal to the cloud server system 8. Moreover, although only one data storage 26 is illustrated in FIG. 1, in some examples, multiple instances of data storage 26 that are configured in different manners could be implemented. The printer record can be indexed in the data storage 26 by the destination printer ID of the print message. The printer record for the destination printer 10 can include, for example data that can indicate a native protocol for the destination printer 10, which native protocol can be employed to print the multiple images of the multi-image file at the destination printer 10. In one example, such data could be implemented as a model number for the destination printer 10.

The cloud server 22 can employ a rendering engine 28 to extract each of the images from the multi-image file, and generate a set of commands in the native protocol for the destination printer 10 for printing each of the images. The set of commands can be implemented, for example, as printer command language (PCL) commands, portable document format (PDF) commands, HEWLETT PACKARD® Graphics Language (HPGL), commands, etc. The cloud server 22 can provide the set of commands in an instruction message for the destination printer 10. To provide the instruction message, the cloud server 22 can include a printer driver for the destination printer 10. In some examples, the printer driver for the printer could be provided to the cloud server 22 from an external system (e.g. a web service).

Upon receipt of the instruction message, the destination printer 10 can execute the set of commands stored therein to print the images. Upon completion of the printing, the destination printer 10 can provide the cloud server 22 with a completion message. In response, the cloud server 22 can provide the origin printer 4 with a status update message that indicates that the destination printer 10 has printed the multiple images. The origin printer 4 can provide an indication of the status to the user 12. In some examples, the indication of the status can be provided in the aforementioned GUI and/or as a message printed on paper.

By utilization of the network system 2, the user 12 can print multiple images at the destination printer 10 from the origin printer 4 without the need for physical access to a separate computer. Furthermore, the multiple images can be uploaded (e.g., as an e-mail message) to the cloud server system 8 from the origin printer 4 in a single print message. In this manner, the user 12 would not have to upload individual images for printing at the destination printer 10.

In another example, the user 12 of the origin printer 4 may desire to upload multiple images to an image album. In such a situation, the user 12 can employ the GUI of the origin printer 4 to select multiple images from the memory 14, such that a multi-image file is generated in the manner described herein. Moreover, the user 12 can select that the images are to be uploaded to an image album. In some examples, the user 12 can also enter album credentials (e.g., a username and password) needed to access the image album. In some examples, the album credentials can be associated with the user 12, additionally or alternatively, in other examples the album credentials can be associated with the origin printer 4. In response, the origin printer 4 can generate an album message. FIG. 3 illustrates an example of an album message 100 that could be generated by the origin printer 4. The album message can include an origin printer ID, labeled in FIG. 1 as “ORIGIN PRINTER ID” and album credentials, labeled in FIG. 1 as “ALBUM CREDENTIALS.” Additionally, the album message 100 can include a multi-image file 102 that stores M number of images 104, 106 and 108, where M is an integer greater than or equal to two. Referring back to FIG. 1, the album message can be provided to the cloud server system 8.

The cloud server 22 of the cloud server system 8 can receive the album message. The album message could be provided, for example, over a hypertext transfer protocol secure (HTTPS) channel established between the origin printer 4 and the cloud server 22. In response to the album message, the cloud server 22 can employ the rendering engine 28 to extract the images from the multi-image file, and convert the images into a format suitable for upload to an image album system 30. The image album system 30 can be implemented, for example, as a web-based image album storage system. Moreover, the cloud server 22 can upload converted images, along with the album credentials to the image album system 30. In response, the image album system 30 can store the multiple images in an image album associated with the user 12 and/or the origin printer 4. In some examples, the image album system 30 can store the image album in the data storage 26. In such a situation, the data storage 26 could be implemented on a storage server.

Upon storing the multiple images, the image album system 30 can provide the cloud server 22 with a completion message. Accordingly, the cloud server 22 can provide a status update message of completion to the origin printer 4, which can in turn, provide the user 12 with a notification (via the GUI and/or a printed message) confirming that the image alum system 30 has stored the multiple images. Thus, at a later time the same or different printer (e.g., the origin printer 4 and/or the destination printer 10) can access the album associated with the user 12 and/or the origin printer 4 (or some portion thereof) and select and print images stored in the album associated with the user 12 and/or the origin printer 4. For instance, the image album system 30 may provide a mechanism to share a given album (or some portion thereof) with another user. In other situations, users could exchange credentials (e.g., usernames and passwords) to allow access to a given album. In this manner, the user 12 need not perform individual uploads of images for the album associated with the user 12 and/or the origin printer 4. Instead, a single upload can provide multiple images.

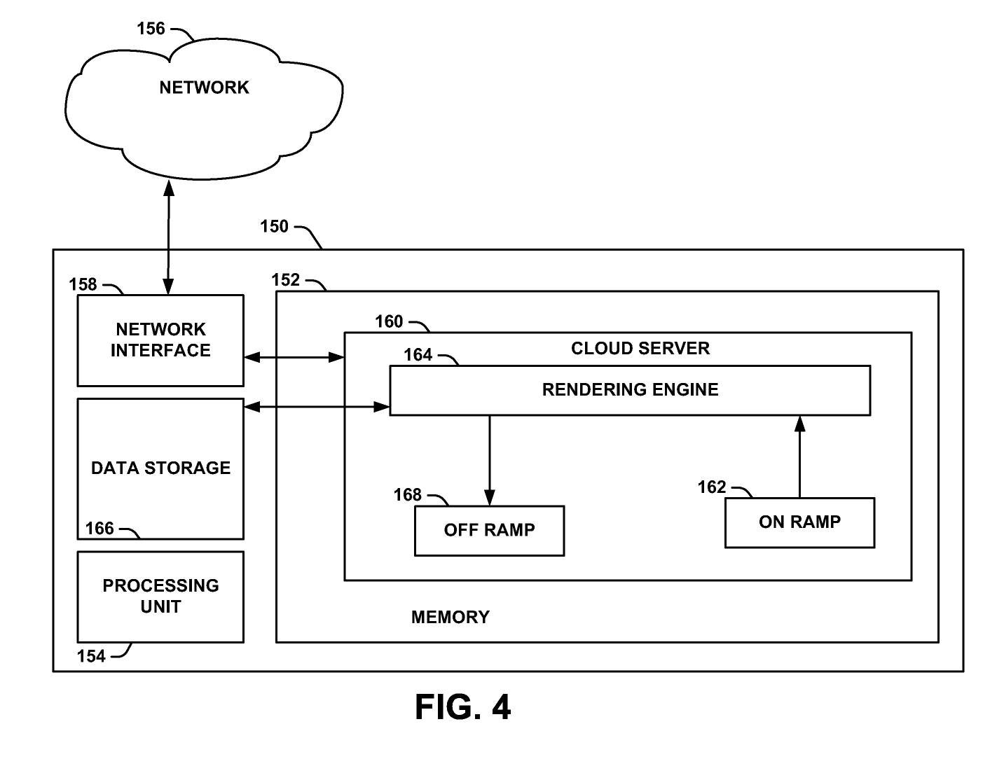

FIG. 4 illustrates an example of a cloud server system 150 that can be utilized to implement the cloud server system 8 illustrated in FIG. 1. The cloud server system 150 can include a memory 152 for storing computer executable instructions. The memory 152 could be implemented, for example, as random access memory, flash memory, a hard disk, a combination thereof, etc. The cloud server system 150 can also include a processing unit 154 that can access the memory 152 and executes computer executable instructions. The processing unit 154 can be implemented, for example, as a processor core. The cloud server system 150 can be coupled to a network 156 (e.g., the Internet) via a network interface 158, which could be implemented as a network interface card. The memory 152 can include a cloud server 160 that can process print messages and album messages.

The cloud server 160 can include an on ramp 162 that receives a print message with a multi-image file containing multiple images to be printed at a destination printer. The print message can be implemented, for example, as an e-mail message. The on ramp 162 can provide the print message to a rendering engine 164 of the cloud server 160. The rendering engine 164 can evaluate a destination ID in the print message and retrieve a printer record from a data storage 166 of the cloud server system 150 for the printer associated with the destination ID, wherein the printer can be referred to as an indentified printer. The data storage 166 can include, for example, a database and/or a table that can store the printer record. The data storage 166 can be implemented, for example as volatile memory (e.g., RAM) or non-volatile memory (e.g. a hard disk and/or a flash drive). The printer record can include routing information (e.g., a network address) of the identified printer. The printer record can further include data that characterizes printing capabilities of the identified printer. The rendering engine 164 can extract each of the multiple images from the multi-image file and generate a set of commands for printing each of the multiple images in a protocol native to the identified printer (e.g., PCL, PDF, HPGL, etc.). The set of commands can be provided to an off ramp 168 of the cloud server 160.

The off ramp 168 can send the set of commands as an instruction message to the identified printer over the network 156, thereby causing the identified printer to process the set of commands. The processing of the set of commands can result, for example, in printing of the multiple images at the identified printer. The off ramp 168 can receive a status message from the identified printer. The status message could be implemented, for example as a completion message indicating that the identified printer has printed the multiple images, as described herein with respect to FIG. 1. In response to the completion message, the off ramp 168 can provide a status update message to the origin printer, which can be indentified from the origin printer ID in the print message.

In another example, the cloud server 160 can receive an album message. The album message can include, for example, an origin printer ID and album credentials (e.g., a username and password). The album message can also include a multi-image file, similar to the multi-image file included in the print message. The cloud server 160 can provide the album message to the rendering engine 164. In response to the album message, the rendering engine 164 can extract each of the multiple images from the multi-image file, and convert the images into a format suitable for uploading to an image album system. In some examples, the converted images can be implemented as a plurality of discrete files, while in other examples the converted images could be implemented as a single file that stores multiple images. The converted images can be provided to the off ramp 168. The off ramp 168 can provide the converted images, along with the album credentials to the image album system via the network 156. The off ramp 168 can receive an acknowledgment message from the image album system, which acknowledgment message acknowledges that the multiple images have been stored in an image album associated with the album credentials. Moreover, the off ramp 168 can provide a message to the sender of the album message, namely, the printer associated with the origin printer ID of the album message indicating that the images in the multi-image file have been stored in the album associated with the album credentials.

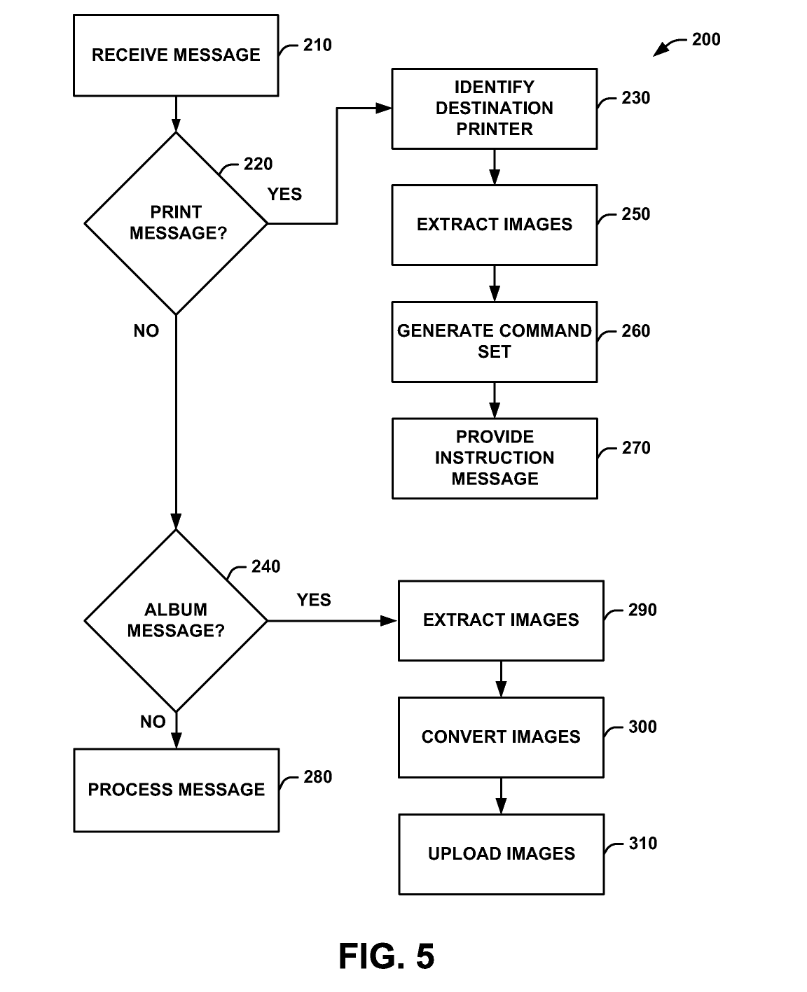

In view of the foregoing structural and functional features described above, example methods will be better appreciated with reference to FIGS. 5-8. While, for purposes of simplicity of explanation, the example methods of FIGS. 5-8 are shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method.

FIG. 5 illustrates a flow chart of an example method 200 for processing multiple images in a single message. The method 200 could be executed, for example, by a cloud server system (e.g., included in the network system 2 illustrated in FIG. 1 and/or the cloud server system 150 illustrated in FIG. 4). At 210, a message can be received by the cloud server system. The message can be provided by an origin printer, such as the origin printer 4 illustrated in FIG. 1. At 220, a determination can be made as to whether the received message is a print message, such as a message provided as an e-mail message, as described with respect to FIGS. 1 and 4. The determination can be based, for example, on a message type of the message received at the cloud server system. For instance, if the message received is an e-mail message with a recipient address of a printer, the received message can be deemed to be a print message. If the determination at 220 is positive (e.g., YES) the method 200 can proceed to 230. If the determination at 220 is negative (e.g., NO), the method 200 can proceed to 240.

At 230, a destination printer can be identified. The destination printer can be identified, for example, based on a destination printer ID included in the print message. Identification can include, for example, retrieval of a printer record for the destination printer based on the destination printer ID. At 240, multiple images are extracted from a multi-image file included with the print message. At 260, a command set in a native protocol (e.g., PCL, PDF, HPGL, etc.) for the destination printer can be generated based on the multiple images. The command set, when executed, can cause the destination printer to print the multiple images. At 270, an instruction message for the destination printer can be provided to the destination printer. Upon receive of the instruction message, the set of commands provided in the instruction message can be executed by the destination printer to print the multiple images provided in the print message.

At 240, a determination can be made as to whether the message (received at 210) is an album message. The determination can be based, for example, on a header of the message. If the determination at 240 is negative (e.g., NO), the method 200 can proceed to 280. If the determination at 240 is positive (e.g., YES), the method 200 can proceed to 290. At 280, the message can be processed according to the type of message received, since it has been determined that the received message is neither a print message nor an album message.

At 290, images can be extracted from a multi-image file in the album message. At 300, the images can be converted (e.g., by the rendering engine) into a format native to an image album system. At 310, the converted images, along with album credentials (e.g., a username and password) for a user and/or the origin printer can be uploaded to the image album system.

By utilization of the method 200, a user of the origin printer can print multiple images on the destination printer with a single message provided to the cloud server. Moreover, in other examples, the user can upload multiple images for an image album with a single message.

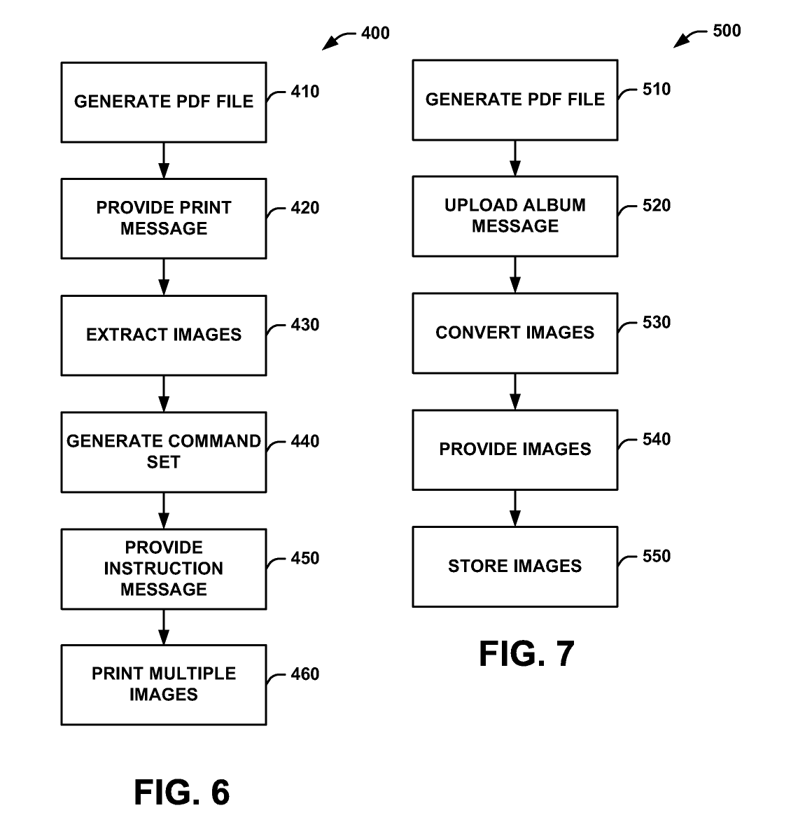

FIG. 6 illustrates a flowchart of an example method 400 for processing a print message. At 410, a PDF file containing multiple images can be generated, for example, by an origin printer. At 420, a print message with the PDF file attached can be provided from the origin printer to a cloud server of a cloud server system via an e-mail server. At 430, a rendering engine of the cloud server can extract multiple images from the PDF file. At 440, a command set can be generated for a destination printer identified in the print message. The command set can include, for example, instructions in a native protocol for the destination printer for printing the multiple images. At 450, an instruction message can be provided to the destination printer that includes the command set. At 460, the destination printer can print the multiple images, by employing the command set.

FIG. 7 illustrates a flowchart of an example method 500 for processing an album message. At 510 a PDF file containing multiple images can be generated, for example, by an origin printer. At 520, an album message containing the PDF file can be uploaded (e.g., via HTTPS) to a cloud server of a cloud server system. The album message can also contain credentials (e.g., a username and password) for an image album associated with the origin printer and/or a user of the origin printer. At 530, a rendering engine of the cloud server can convert the multiple images from the PDF file included in the album message into a format suitable for an album system. At 540, the converted images can be provided to the album system, along with the credentials included in the album message. At 550, the album system can store images in an album that is stored in data storage, such as a storage server.

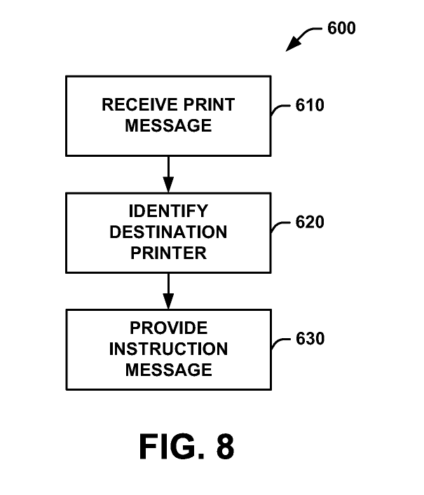

FIG. 8 illustrates another flowchart of an example method 600 for processing multiple images received in a single message. At 610, a print message can be received from an origin printer. The print message can comprise a multi-image file that stores a plurality of images. At 620, based on a destination printer ID of the print message, a destination printer to print the plurality of images can be identified. At 630, an instruction message can be provided to the destination printer, the instruction message can comprise a set of commands for printing the plurality of images at the destination printer.

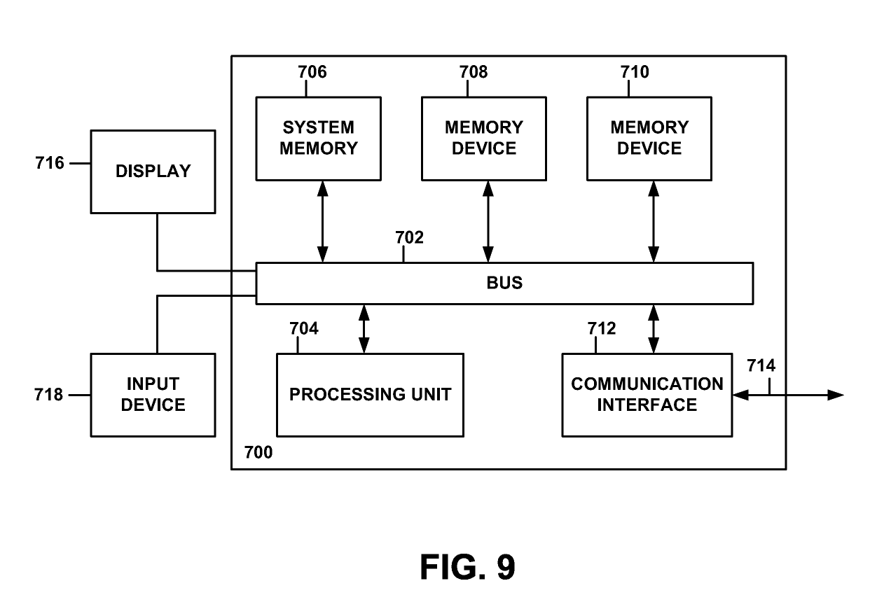

FIG. 9 is a schematic block diagram illustrating an example system 700 of hardware components capable of implementing examples disclosed in FIGS. 1-8, such as the cloud server system 8 and portions of the origin printer 4 and/or the destination printer 10 illustrated in FIG. 1 and/or the cloud server system 150 illustrated in FIG. 4. The system 700 can include various systems and subsystems. The system 700 can be a personal computer, a laptop computer, a workstation, a computer system, an appliance, an application-specific integrated circuit (ASIC), a server, a server blade center, a server farm, a mobile device, such as a smart phone, a personal digital assistant, an interactive television set, an Internet appliance, portions of a cloud printer, etc.

The system 700 can include a system bus 702, a processing unit 704, a system memory 706, memory devices 708 and 710, a communication interface 712 (e.g., a network interface), a communication link 714, a display 716 (e.g., a video screen), and an input device 718 (e.g., a keyboard and/or a mouse). The system bus 702 can be in communication with the processing unit 704 and the system memory 706. The additional memory devices 708 and 710, such as a hard disk drive, server, stand alone database, or other non-volatile memory, can also be in communication with the system bus 702. The system bus 702 operably interconnects the processing unit 704, the memory devices 706-710, the communication interface 712, the display 716, and the input device 718. In some examples, the system bus 702 also operably interconnects an additional port (not shown), such as a universal serial bus (USB) port.

The processing unit 704 can be a computing device and can include an application-specific integrated circuit (ASIC). The processing unit 704 executes a set of instructions to implement the operations of examples disclosed herein. The processing unit can include a processor core.

The additional memory devices 706, 708 and 710 can store data, programs, instructions, database queries in text or compiled form, and any other information that can be needed to operate a computer. The memories 706, 708 and 710 can be implemented as computer-readable media (integrated or removable) such as a memory card, disk drive, compact disk (CD), or server accessible over a network. In certain examples, the memories 706, 708 and 710 can comprise text, images, video, and/or audio.

Additionally, the memory devices 708 and 710 can serve as databases or data storage such as the data storage 26 and/or the memory 14 illustrated in FIG. 1. Additionally or alternatively, the system 700 can access an external system (e.g., a web service) through the communication interface 712, which can communicate with the system bus 702 and the communication link 714.

In operation, the system 700 can be used to implement, for example, an origin printer, a cloud server, a destination printer and at least some components in other systems that can be employed in a system that provides multiple images. Computer executable logic for implementing the system, such as the memory 20 of the cloud server system 8 illustrated in FIG. 1 and or the cloud server system 150 illustrated in FIG. 4, can reside in the system memory 706, and/or in the memory devices 708 and/or 710 in accordance with certain examples. The processing unit 704 executes computer executable instructions originating from the system memory 706 and the memory devices 708 and 710. In such an example, the system memory 706 and/or the memory devices 708 and/or 710 could be employed, for example, to implement the memory 14 illustrated in FIG. 1 and/or the memory 14 illustrated in FIG. 1. The term “computer readable medium” as used herein refers to a medium that participates in providing instructions to the processing unit 704 for execution.

Where the disclosure or claims recite “a,” “an,” “a first,” or “another” element, or the equivalent thereof, it should be interpreted to include one or more than one such element, neither requiring nor excluding two or more such elements. Furthermore, what have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

What is claimed is:

1. A network system for providing multiple images comprising:
a system comprising:
a memory for storing computer executable instructions; and
a processing unit for accessing the memory and executing the computer executable instructions, the computer executable instructions comprising:
a server to:
receive a print message from an origin printer that includes a multi-image file that stores a plurality of images; and
generate a set of commands for printing the plurality of images in a protocol associated with a destination printer identified in the print message.

2. The network system of claim 1, wherein the server is further to provide an instruction message that includes the set of commands to the destination printer.

3. The network system of claim 1, wherein the multi-image file is a portable document format (PDF) file.

4. The network system of claim 1, wherein the multi-image file is a first multi-image file and the server is further to:
receive an album message that comprises a second multi-image file that stores a plurality of images;
convert the plurality of images stored in the second multi-image file into a format associated with an image album system; and
provide the image album system with (i) the converted plurality of images and (ii) album credentials for accessing an image album stored by the image album system.

5. The network system of claim 1, wherein the print message comprises an e-mail message.

6. The network system of claim 1, wherein the print message comprises:
an origin printer ID that identifies the origin printer; and
a destination printer ID that identifies the destination printer.

7. The network system of claim 6, wherein the server is further to retrieve a printer record from data storage for the destination printer based on the destination printer ID.

8. The network system of claim 1, wherein the origin printer comprises an image merger to merge a plurality of image files to generate the multi-image file.

9. The network system of claim 8, wherein each of the image files comprises one of a JPEG file, a raw image format file, a portable network graphics (PNG) file and the multi-image file comprises a portable document format (PDF) file.

10. A method for processing multiple images comprising:
receiving a print message from an origin printer, the print message comprising a multi-image file that stores a plurality of images;
identifying, based on a destination printer ID of the print message, a destination printer to print the plurality of images; and
providing an instruction message to the destination printer, the instruction message comprising a set of commands for printing the plurality of images at the destination printer.

11. The method of claim 10, further comprising generating the set of commands in a protocol associated with the destination printer.

12. The method of claim 10, wherein the multi-image file comprises a portable document format (PDF) file.

13. The method of claim 10, wherein the multi-image file is a first multi-image file, the method further comprising:
receiving an album message from the origin printer, the album message comprising a second multi-image file and album credentials for accessing an image album; and
converting the plurality of images stored in the second multi-image file into a format associated with an image album system.

14. The method of claim 13, further comprising providing (i) the converted plurality of images and (ii) the album credentials to the image album system via a network.

15. A network system for providing a plurality of images comprising:
an origin printer coupled to a network, the origin printer comprising:
an image merger to merge a plurality of selected image files stored in memory into a multi-image file;
a destination printer coupled to the network;
an image album system coupled to the network; and
a cloud server system coupled to the network, the cloud server system comprising:
a memory for storing computer executable instructions; and
a processing unit for accessing the memory and executing the computer executable instructions, the computer executable instructions comprising:
a cloud server comprising:
an on ramp to receive a print message or an album message from the origin printer;
wherein the print message comprises:
the multi-image file; and
a destination ID that identifies the destination printer;
wherein the album message comprises:
the multi-image file; and
album credentials for accessing an image album stored at the image album system;
a rendering engine to:
in response to the print message, retrieve a printer record for the destination printer from data storage based on the destination ID of the print message;
in further response to the print message, convert the multi-image file into a set of commands for printing the plurality of images in a protocol associated with the destination printer; and
in response to the album message, convert the plurality of images into a format associated with the image album system; and
an off ramp to:
in response to the print message, provide an instruction message that includes the set of commands to the destination printer; and
in response to the album message, provide the converted plurality of images and the album credentials to the image album system.
